(19) United States
(12) Patent Application Publication
(10) Pub. No.: US 2026/0154640 A1
(43) Pub. Date: Jun. 4, 2026

(54) TACIT KNOWLEDGE CAPTURE

(71) Applicant: British Telecommunications Public Limited Company, London Greater London (GB)

(72) Inventors: Anasol PENA RIOS, London (GB); Hugo LEON GARZA, London (GB); Ozkan BAHCECI, London (GB)

(21) Appl. No.: 19/122,588

(22) PCT Filed: Oct. 3, 2023
(86) PCT No.: PCT/EP2023/077329

§ 371 Date: Apr. 18, 2025

(30) Foreign Application Priority Data
Oct. 27, 2022 (EP) 22204239.2

(51) Int. Cl. G06Q 10/0633; G06F 3/01; G09B 5/12

(52) U.S. Cl. CPC G06Q 10/0633; G06F 3/011; G09B 5/12

(57) ABSTRACT

Methods and systems for capturing tacit knowledge data from an expert user and methods and systems for using the captured tacit knowledge data to assist a novice user. Steps of a computer-implemented method for capturing tacit knowledge data from an expert user comprise: receiving expert data, analysing the expert data, and storing the sequence of expert actions in a database. The expert data comprises expert real-time data received while the expert user performs a task. The expert real-time data comprises expert sensor data from a first plurality of sensors monitoring the expert user and/or the surroundings of the expert user. Analysing the expert data uses a machine learning system to determine what actions the expert user has performed. The analysing comprises classifying the expert data to determine expert actions that the expert has performed and clustering the expert actions into a sequence of expert actions.

### TECHNICAL FIELD

Embodiments of the present invention described herein relate to methods and systems for capturing tacit knowledge data from an expert user and methods and systems for using the captured tacit knowledge data to assist a novice user.

### BACKGROUND

Training specialized workers represents a considerable overhead in any business. In addition, the increasing complexity and number of variants in underlying technologies is complicating the process of ensuring that the workforce is permanently up-to-date and knowledgeable on every technology and product involved in the services companies provide. Furthermore, the risk of losing crucial knowledge that cannot easily be replaced when expert employees leave an organisation (e.g., retirement of aging workforce) is another factor that needs to be considered. Challenges include how to quickly on boarding new employees and how to effectively transfer and maintain knowledge within the organisation.

### SUMMARY OF THE DISCLOSURE

The present disclosure addresses the above problem of how to effectively transfer and maintain knowledge, specifically tacit knowledge, by providing methods and systems which capture knowledge from experts in real-time.

In view of the above, from a first aspect, the present disclosure relates to a computer-implemented method for capturing tacit knowledge data from an expert user, the method comprising: receiving expert data, the expert data comprising expert real-time data received while the expert user performs a task, the expert real-time data comprising expert sensor data from a first plurality of sensors monitoring the expert user and/or the surroundings of the expert user; analysing the expert data using a machine learning system to determine what actions the expert user has performed, wherein the analysing comprises: classifying the expert data to determine expert actions that the expert has performed; and clustering the expert actions into a sequence of expert actions; and storing the sequence of expert actions in a database.

Several advantages are obtained from embodiments according to the above described aspect. For example, the above aspect allows crucial knowledge which is hard to document using conventional methods to be captured and stored as a sequence of expert actions.

This captured tacit knowledge may then be used to train and guide non-expert (novice) users to perform the same or similar tasks.

In some embodiments, clustering comprises using a k-nearest neighbours (KNN) algorithm and/or k-means clustering.

In some embodiments, the method further comprises using the stored sequence of expert actions to guide a novice user attempting to complete the task.

In some embodiments, the method further comprises synchronising the expert sensor data from the first plurality of sensors prior to the analysis.

In some embodiments, the expert data further comprises pre-existing data relating to a task description or technical documentation related to the task.

In some embodiments, the analysing further comprises removing meaningless actions from the determined expert actions prior to the storing step.

In some embodiments, the expert sensor data comprises data relating to one or more of: the expert user's body position, the expert user's hand position, the expert user's hand rotation, the expert user's hand gestures, the expert user's body gait, the expert user's eye gaze, location of the expert user within the expert user's surroundings, sound in the expert user's surroundings, light intensity in the expert user's surroundings, temperature in the expert user's surroundings, objects detected in the expert user's surroundings, and/or objects detected which the expert user is interacting with.

In some embodiments, the first plurality of sensors comprises one or more of: wearable sensors worn by the expert user, a camera, an eye tracker, a heart rate sensor, wrist bands, a microphone, a light sensor and/or a thermometer.

From a second aspect, the present disclosure relates to a computer-implemented method for guiding a novice user attempting a task, the method comprising: receiving first novice data, the first novice data comprising first novice real-time data received while the novice user attempts the task, the first novice real-time data comprising first novice sensor data from a second plurality of sensors monitoring the novice user and/or the surroundings of the novice user; accessing a database which stores one or more sequences of expert actions, wherein the one or more sequences of expert actions have been determined by processing data captured from an expert user; comparing the first novice data to the one or more sequences of expert actions; identifying a sequence of expert actions which meets a first predetermined threshold of similarity with the first novice data; analysing the first novice data using a machine learning system to determine what actions the novice user is performing, wherein the analysing comprises: classifying the first novice data to determine novice actions that the novice user is performing; comparing the determined novice actions to the sequence of expert actions from the identified sequence of expert actions in the database; communicating feedback to the novice user to guide the novice user if the comparison between the determined novice actions and the sequence of expert actions does not meet a second predetermined similarity threshold.

Several advantages are obtained from embodiments according to the above described aspect. For example, this allows a novice user to be trained/guided virtually. Tacit knowledge can be transferred without the presence of an expert. Expert knowledge harvested from experts who are no longer available can be used to train novices.

In some embodiments, the one or more sequence of expert actions stored in the database have been determined by processing data captured from the expert user in accordance with the first aspect.

In some embodiments the method further comprising checking whether or not the novice actions produced a desired outcome of the task.

In some embodiments the method further comprises storing the novice actions in the database if the desired outcome of the task was produced.

In some embodiments the method further comprises capturing mistake data and storing the mistake data in an errors database if the desired outcome of the task was not produced.

In some embodiments the method further comprises communicating further feedback to the novice user to notify them of their mistakes if the desired outcome of the task was not produced.

In some embodiments the method further comprises checking if the novice user is following the feedback by: receiving second novice data while the novice user continues to attempt the task, the second novice data comprising second novice real-time data, the second novice real-time data comprising second novice sensor data from the second plurality of sensors; analysing the second novice data using artificial intelligence to determine what actions the novice user is performing, wherein the analysing comprises: classifying the second novice data to determine novice actions that the novice user has performed; comparing the determined novice actions to the sequence of expert actions from the identified sequence of expert actions in the database.

In some embodiments, the first and/or second novice data further comprises pre-existing data relating to a task description or technical documentation related to the task.

In some embodiments, the first and/or second predetermined threshold of similarity is calculated using a similarity function which optionally comprises one or more of: regression, classification, ranking and local sensitive hashing (LSH).

In some embodiments, the feedback is communicated via one or more of: visual communication methods, auditive communication methods or haptic feedback.

In some embodiments, visual communication methods comprise one or more of: holograms, diagrams, or animations of the expert actions.

In some embodiments, auditive communication methods comprise voice guided instructions.

In some embodiments, haptic feedback is via one or more of: haptic response to controllers or haptic gloves.

From a third aspect, the present disclosure relates to a system comprising: a processor; and a memory including computer program code. The memory and the computer code configured to, with the processor, cause the system to perform the method of any of the above aspects.

### BRIEF DESCRIPTION OF THE DRAWINGS

Embodiments of the present invention will now be further described by way of example only and with reference to the accompanying drawings, wherein:

FIG. 1 is a block diagram of a system according to an embodiment of the present invention.

FIG. 2 is a timeline illustrating embodiments of the present invention.

FIG. 3 is a flowchart illustrating embodiments of the present invention.

FIG. 4 is a flowchart illustrating embodiments of the present invention.

FIG. 5 is a flowchart illustrating embodiments of the present invention.

FIG. 6 illustrates the stages of embodiments of the present invention.

FIG. 7 is a flowchart illustrating embodiments of the present invention.

FIG. 8 is a flowchart illustrating embodiments of the present invention.

FIG. 9 is a flowchart illustrating embodiments of the present invention.

FIG. 10 is a flowchart illustrating embodiments of the present invention.

### DESCRIPTION OF THE EMBODIMENTS

Key terms related to embodiments of the present invention are explained in detail below.
Tacit Knowledge: This is knowledge you can only gain through experience. It is difficult to document and share tacit knowledge using traditional methods. Few examples include how we learn to speak another language, how to pitch a sale or one's leadership skills. Tacit knowledge is often expressed as actions, behaviours, intuitions, instincts, and routines. This knowledge is unbelievably valuable to companies in understanding different perspectives and to train new employees.
Explicit Knowledge: This is knowledge that can be easily shared and documented. Few examples include cookbooks, manuals, technical knowledge on how to do things in certain order such as a process. This knowledge can be used to assist new employees, streamline organisational practices, and create a source of collective knowledge.
Knowledge Management: This is the process of documenting, distributing, and using knowledge within a collective. Key aspects of successful knowledge management are to provide easy methods of documenting explicit or tacit knowledge. Furthermore, this includes providing easy access to knowledge. In an organisational context, successful knowledge management system can provide competitive advantage, continuous improvement to organisational practices and distribution of lesson learned from one's experience to rest of the organisation. This knowledge can be stored in the form of an internal library, an internal form, or any type of human readable medium. Moreover, the adoption of Industry 4.0 is increasing the complexity of data available to collect and transform into knowledge.
Machine Learning: Study of computer algorithms that can create meaning from data. These algorithms can learn from data and examples. This data is then converted into knowledge or a description of the data.
   Classification: Predicting a class/label of an input based on a data set of examples.
   Clustering: Grouping set of inputs based on a similarity metric. Clustering may comprise using a k-nearest neighbours (KNN) algorithm and/or k-means clustering.
   Association Techniques: Finds relations between data variables for further analysis. This method usually checks dependency, correlation, and variance between variables.
Similarity Learning: area of supervised machine learning in artificial intelligence. It is closely related to regression and classification, but the goal is to learn a similarity function that measures how similar or related two objects are. There are four common setups for similarity and metric distance learning: regression, classification, ranking and Local sensitive hashing (LSH).
Extended Reality: Umbrella term refereeing to all virtual and physical crossing environments that humans can interact with.
   Virtual Reality: Computer-generated simulation of a three-dimensional environment that can be interacted with in a seemingly real or physical way using special electronic equipment.
   Augmented Reality: Technology that superimposes a computer-generated image on a user's view of the real world, thus providing a composite view.
   Mixed Reality: A medium consisting of immersive computer-generated environments in which elements of a physical and virtual environment are combined.
Internet of Things: Physical objects with sensors, processing ability, software, and other technologies that connect and exchange data with other devices and systems over the Internet or other communications networks.
Eye Tracking: Is the process of measuring eye movements to determine where a person is looking, what they are looking at, and for how long their gaze is in a particular spot. Because our eyes are one of the primary tools, we use vision for decision making and learning, eye tracking is commonly used to study human behaviour because it is an accurate way to objectively measure and understand visual attention. An eye tracker uses invisible near-infrared light and high-definition cameras to project light onto the eye and record the direction it is reflected off the cornea. Advanced algorithms known in the art are then used to calculate the position of the eye and determine exactly where it is focused. One example of an eye tracking algorithm is: (i) use infrared LEDs directed onto the eye; (ii) compute the relative distance of that light to the pupil of the eye as a means to determine eye movement. Deep learning techniques such as Convoluted Neural Networks (CNN) can be used to track the eye. This makes it possible to measure and study visual behaviour and fine eye movements, as the position of the eye can be mapped multiple times a second. How quickly an eye tracker can capture these images is known as its frequency. A recording can also be made of the scene a person is looking at and using eye tracking software it is possible to produce a visual map of how the person viewed elements of the scene. There types of eye tracking devices include:
   Screen based—These are stand-alone, remote devices which either come as an individual unit or a smaller panel which can be attached to a laptop or monitor.
   Wearable—These include eye tracking glasses and virtual reality (VR) headsets with integrated eye tracking.
   Webcam—Webcam eye trackers do not have sensors or specialized cameras; they are solely comprised of the webcam device attached or built-in to a computer.

### Overview

Reduction in technology cost and increasing availability is pushing enterprises and consumers to adopt disruptive technologies such as IoT (Internet of Things) sensors, cameras, and wearables to their daily tasks. These devices usually have several sensors that can track human activity and spatial information about the environment. Embodiments of the present invention take advantage of available sensors, cameras, and other input information devices in the environment to document tacit knowledge from human activity. However, the invention is not limited to monitoring humans only, the invention could also be used to monitor any physical entity such as a machine, vehicle or robot while it undertakes one or more tasks. Tacit knowledge refers to any knowledge that is hard to document using traditional methods. This knowledge can be referred to as expertise or know-how that it is commonly learned through experience. It is hard to transfer this knowledge by telling someone or writing it down as a document. Therefore, it is harder to transfer or document this knowledge compared to explicit knowledge.

Embodiments of the present invention use machine learning, computer vision (cameras), IoT devices (sensors) and wearables to collect data from an expert user (which may be human, robot, machine, vehicle, etc.) in real-time (e.g., movements, actions, eye tracking, emotion detection from face tracking, heart rate from biometrics). This data is then analysed using known machine learning models such as clustering and classification. The outcome of this analysis documents the tacit knowledge expert characterised (practiced) whilst working on a task that requires practical knowledge.

The analysis of this data is then saved and used as a benchmark to assist anyone who works on a similar task with the potential to increase learning rate on novice users and avoid reworking. The assistance is provided via visual information (e.g., holograms, diagrams, expert's actions animations), auditive information (e.g., voice-guided instructions), haptic feedback (e.g., haptic responses to controllers, haptic gloves, etc.) and other forms of 2D and 3D multimedia feedback.

This process automates conversion of tacit to explicit knowledge by documenting practical tasks and storing hard-to-document expert knowledge.

Embodiments of the present invention capture tacit knowledge data from expert users (i.e., those who have the tacit knowledge in question) via sensors to encapsulate their expertise, analyse the captured data using known AI techniques, and then use the analysed data to guide and provide feedback to non-expert users (“novice” users) that are not able to complete the task correctly or need additional guidance.

In other words, embodiments of the present invention monitor a physical entity (e.g., a human, a machine, a vehicle, a robot or any combination thereof) while the entity undertakes one or more tasks. The physical entity may be described herein as an “expert user”. Embodiments of the present invention learn the behaviours and actions of the entity and the responsive actions of the resources and/or equipment with which the entity interacts. The leaning is performed using conventional AI techniques. Embodiments of the present invention generate a model of the task(s), the interactions between entities and engagement of entities with resources. The model comprises a sequence of expert actions. The model is then deployed to inform other entities (novice users) seeking to achieve comparable outcomes. The model can be deployed autonomously, or can be used to train other entities. The objective is to increase efficacy of the repetition of tasks and transfer of knowledge between entities.

In more detail, embodiments of the present invention comprise one or more of the three following stages:
1. Data collection
2. Expert data analysis
3. Real-time tasks check & user assistance

With embodiments of the present invention it is possible to create a digital database of tacit knowledge for skill-based tasks. Benefits of embodiments of the present invention include companies being capable of transferring knowledge through digital technologies instead of excessive cost and time consuming in-person trainings.

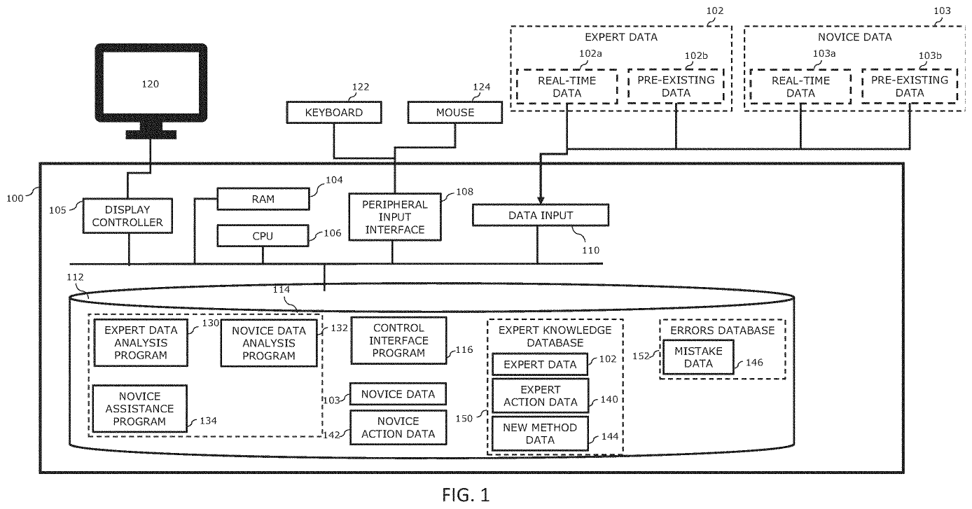

Various aspects and details of these principal components will be described below with reference to FIGS. 1 to 10.

### The Computer System

An example of a computer system used to perform embodiments of the present invention is shown in FIG. 1.

FIG. 1 is a block diagram illustrating an arrangement of a system according to an embodiment of the present invention. Some embodiments of the present invention are designed to run on general purpose desktop or laptop computers. Therefore, according to an embodiment, a computing apparatus 100 is provided having a central processing unit (CPU) 106, and random access memory (RAM) 104 into which data, program instructions, and the like can be stored and accessed by the CPU. The apparatus 100 is provided with a display screen 120, and input peripherals in the form of a keyboard 122, and mouse 124. Keyboard 122, and mouse 124 communicate with the apparatus 100 via a peripheral input interface 108. Similarly, a display controller 105 is provided to control display 120, so as to cause it to display images under the control of CPU 106. Expert data 102 (comprising real-time data 102a (e.g., data collected by sensors in real-time as the expert is performing a task) and pre-existing data 102b (e.g., existing information about the task assigned to the expert and/or existing (explicit) knowledge available on the technical details around the task, equipment and/or tools)) and novice data 103 (similarly comprising real-time data 103a and pre-existing data 103b) can be input into the apparatus and stored via data input 110. The expert data 102 may be stored in an expert knowledge database 150. In this respect, apparatus 100 comprises a computer readable storage medium 112, such as a hard disk drive, writable CD or DVD drive, zip drive, solid state drive, USB drive or the like, upon which expert data 102 and novice data 103 can be stored. Alternatively, the data 102, 103 could be stored on a web-based platform, e.g. a database, and accessed via an appropriate network. Computer readable storage medium 112 also stores various programs, which when executed by the CPU 106 cause the apparatus 100 to operate in accordance with some embodiments of the present invention.

In particular, a control interface program 116 is provided, which when executed by the CPU 106 provides overall control of the computing apparatus, and in particular provides a graphical interface on the display 120 and accepts user inputs using the keyboard 122 and mouse 124 by the peripheral interface 108. The control interface program 116 also calls, when necessary, other programs to perform specific processing actions when required. For example, an expert analysis program 132 may be provided which is able to operate on expert data 102 (comprising real-time data 102a and/or pre-existing data 102b) indicated by the control interface program 116, so as to output expert action data 140, which may be stored in expert knowledge database 150. A novice data analysis program 132 may be provided which is able to operate on novice data 103 (comprising real-time data 103a and/or pre-existing data 103b) indicated by the control interface program 116, so as to output novice action data 142. A novice assistance program 134 may be provided which is able to operate on one or more of expert data 102, expert action data 140, novice data 103 and novice action data 142 indicated by the control interface program 116, so as to output one or more of feedback to the novice user, new method data 144 saved to the expert knowledge database 150 or mistake data 146 saved to the errors database 152. The operations of the expert data analysis program 130, novice data analysis program 132 and novice assistance program 134 are described in more detail below.

The detailed operation of the computing apparatus 100 will now be described. Firstly, the user launches the control interface program 116. The control interface program 116 is loaded into RAM 104 and is executed by the CPU 106. The system user then launches a program 114, which may be comprised of the expert data analysis program 130, novice data analysis program 132 and novice assistance program 134. The programs act on the input data 102, 103 as described below.

### Data Collection

Data collection is described in relation to the collection of the expert data 102 as this is the first step of the process. However, novice data 103 will also later be collected in a similar manner (i.e., collecting real-time data 103a and using pre-existing data 103b as described below).

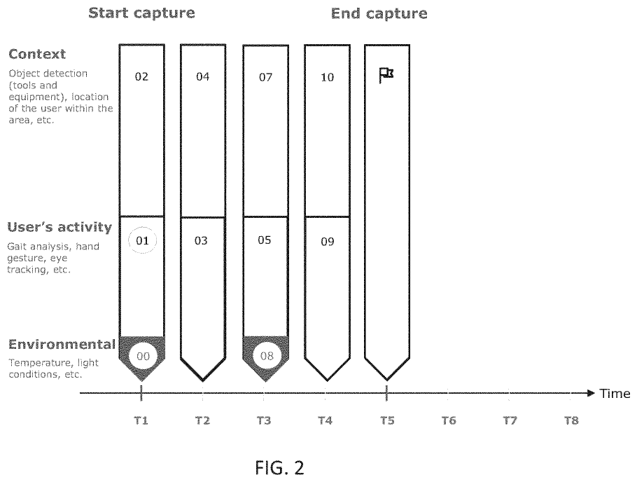

There are two sources of data. Data captured in real-time 102a and pre-existing data 102b. Real-time data collection focuses on capturing diverse sources of data at any given time (T) as shown in FIG. 2. The primary source of data may be an expert user's activity information. This may include data relating to one or more of the expert user's: hand position, hand rotation, body gait and/or eye gaze. This data may then be enriched by context information from additional environmental sensors and/or cameras, and/or any existing documented information such as task description or any technical documentation (referred to as pre-existing data 102b, 103b). Expert user's activity information is used to classify the expert user's current actions and save that information as knowledge. Additional information enriches the knowledge captured and reduces uncertainty.

Examples of real-time data 102a, 103a may include:
Environmental information: Spatial information including conditions of the environment in which the expert user is performing the action such as volume of sound (which may be detected using a microphone), light intensity (which may be detected using a light sensor), and/or temperature (which may be detected using a thermometer).
Context information: The camera(s) or nearby sensor(s) may also detect any objects that are around the expert user or involved in the primary activity the expert user is doing. This is done through machine vision (i.e., object detection) combining sensor(s) and camera(s) information. Objects which may be detected include tools the expert user is using (e.g., screwdriver) or any other key object the expert user is interacting with (e.g., equipment or server to be repaired). This type of data from the environment helps to classify the expert user's actions. Additionally, the camera may capture the location of the expert user within the area the expert user is working in (e.g., their location within a room).
Expert user's activity information: Expert user's activity information is related to the position and/or rotation of the expert user's body. This may be detected using known algorithms for gait analysis and/or hand gesture recognition. Expert user's activity information may also be related to information regarding what the expert user is looking at. This may be detected using eye tracking. Expert user's activity information may also include any information related to the expert user behaviour when performing a task (e.g. heart rate from biometrics and/or emotion detection, etc.).

Examples of pre-existing data 102b, 103b may include:
Task Information: Any existing information on the task assigned to the expert user. This may include a task description, location of the task, and/or notes from previous attempts.
Technical Information: Existing (explicit) knowledge available on the technical details around the task, equipment or/and tools. This may include manuals, documents, and/or any other guidelines.

FIG. 2 illustrates an example of the data collection step in accordance with some embodiments of the present invention. In FIG. 2 at time T1, data capture is started. At times T1 and T3, data relating to context information, the expert user's activity and the expert user's environment is captured. At times T2 and T4, only data relating to context information and the expert user's activity is captured. At time T5, data capture is ended.

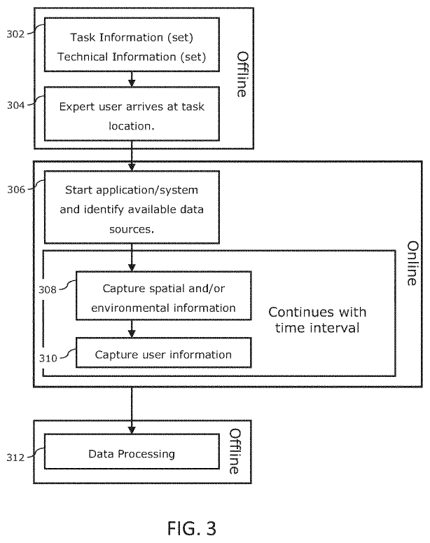

The type of data collected from the expert user will depend on the availability of sensors at the time. Static information (pre-existing data) such as task and technical information may be processed offline whereas collection of spatial and user information (real-time data) is captured in a continuous loop until the expert user completes the task. This is shown in FIG. 3. The captured data (real-time and pre-existing data) is then sent for processing to understand expert knowledge.

FIG. 3 illustrates steps relating to data collection and data processing in accordance with some embodiments of the present invention. At step 302, pre-existing data such as task information and technical information is obtained. At step 304, the expert user arrives at the location where the task is to be performed. Both steps 302 and 304 are done “offline”, i.e., the system does not need to be monitoring the expert user when these steps are performed. At step 306, the system is started (i.e., the system is “online”) and the system identifies the available data sources (e.g., a plurality of sensors). For example, the system may identify that there is: (i) a camera for monitoring the expert user's location within the room where the task is to be performed; (ii) a camera attached to the expert user (e.g. on their head) to monitor what the expert user is doing, e.g. with their hands, and/or to monitor response from equipment the expert user is interacting with; (iii) wrist bands attached at the expert user's wrists to monitor their hand movements; and (iv) an eye tracker, e.g. eye tracking glasses to track the expert user's eye movements. At steps 308 and 310, the system captures real-time data 102a (examples of real-time data are described above). The real-time data 102a is captured in a continuous loop until the expert user completes the task. Data may be captured at a regular time interval, e.g., every millisecond, every 0.5 seconds, every second, every five seconds, every 10 seconds, every 20 seconds, every 30 seconds, every 45 seconds, every minute, every 5 minutes, etc. Different data from different sensors may be captured at different time intervals, for example, eye tracking data may be captured every millisecond and temperature data may be captured every 5 minutes. Any suitable time interval for the data type may be used. The data capture steps 308, 310 are performed online. Once the expert user has completed the task and thus all the data has been collected, the data processing at step 312 may be performed offline—i.e., the data processing for the expert data 102 does not have to be done in real-time when the expert user is at the task site. The raw data 102a can be collected and sent to a database once the expert user has completed the task. This data can be later analysed offline to extract knowledge as explained in detail below.

### Expert Data Analysis

In this stage of the process, data from the various data sources (e.g., data relating to sensors worn by the expert user, data relating to objects identified by object detection from camera imagery, and data relating to the environment the task is performed in) are merged, analysed, clustered and classified into actions, and then clustered into a sequence of actions (a task) using conventional artificial intelligence techniques. This is performed by the expert data analysis program 130 which outputs expert action data 140 (a sequence of expert actions) which may be stored in the expert knowledge database 150. An action is a sequence of gestures, and a task is a sequence of actions. The information being captured in the real-time data collection stage is a data snapshot at a specific point in time (see FIG. 2-T1, T2, T3, etc.). For example, at a given point in time the system captures what was the position and rotation of the expert user's palm of the hand (gesture), what tool was in use, where in the room was the expert user (their location), environmental conditions (e.g., light conditions, temperature, humidity, CO2 levels and/or noise, etc.), the expert user's gait (e.g., body and/or face position), eye positions and/or eye movement, etc. Embodiments of the present invention transform this static data into expert user's actions using conventional classification algorithms. When the additional element of time and relationship between the information is added using conventional artificial intelligence techniques to synchronise the data from the plurality of data sources, we end up with a sequence of actions, i.e., a task (expert action data 140), and thus knowledge of how to perform that task.

Identifying sets of static data that represent knowledge and/or actions is done via conventional computational intelligence techniques and conventional clustering techniques. These conventional techniques are programmed into the expert data analysis program 130. For example, the expert action data 140 can be mapped using a KNN algorithm or an unsupervised algorithm such as K-Means. This enables all expert actions and tasks to be structured in an X dimensional array to do similarity checks. For example, the expert action data (or expert data) may be structured in an X dimensional array, and the novice action data (or novice data) may also be structured in an X dimensional array. This allows similarity checks (described above, e.g., regression, classification, ranking and Local sensitive hashing (LSH)) to be performed on the novice and expert arrays to determine whether the two arrays are over a similarity threshold or not.

Not all of the extracted sets of data are expected to be meaningful. For example, this could be due to the expert checking their phone during their task or having a coffee break. Such actions do not help complete the task and thus it is preferable that they be ignored. Advantageously the expert data analysis program 130 comprises an additional cleaning step which removes non-meaningful actions from the data. This allows key actions to be clustered together as a sequence of expert user actions to complete a task, ignoring the non-meaningful actions.

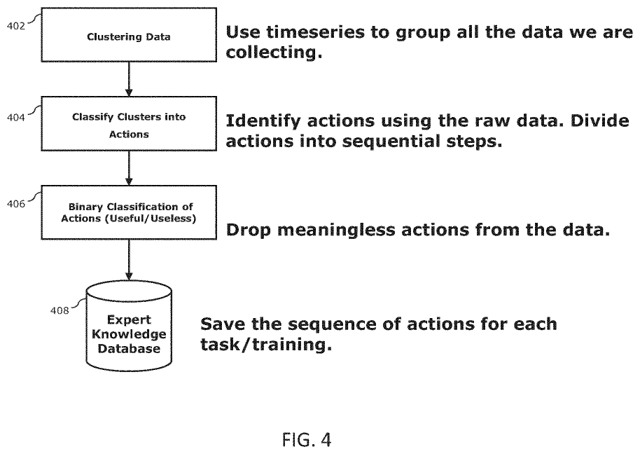

FIG. 4 illustrates the expert data analysis steps in accordance with some embodiments of the present invention. At step 402, a timeseries is used to group real-time data 102a together into steps and actions. This is known as clustering the data. An action is a cluster of steps. A task is a sequence of actions.

As a simplistic example purely for illustration purposes, say the task the expert user is performing is making an instant coffee. The expert user performs the following steps. The expert user takes the coffee powder from the cabinet, expert user opens the coffee powder's lid, expert user grabs a spoon, expert user takes a spoon of coffee powder, expert user adds the coffee powder into the cup, expert user boils the kettle, expert user waits for the kettle, expert user pours hot water from the kettle to the cup, expert user mixes the coffee cup.

An example of clusters here would be:
(1) Action: Access the coffee powder. The steps of action (1) are: The expert user takes the coffee powder from the cabinet, expert user opens the coffee powder's lid.
(2) Action: Add coffee to cup. The steps of action (2) are: expert user grabs a spoon, expert user takes a spoon of coffee powder, expert user adds the coffee powder into the cup.
(3) Action: Add hot water to cup. The steps of action (3) are: expert user boils the kettle, expert user waits for the kettle, expert user pours hot water from the kettle to the cup, expert user mixes the coffee cup.

These are three clusters from real-time events (measured using real-time data 102a). The individual steps are clustered into actions.

At step 404, actions are identified using the raw clustered data (the raw data being clustered into steps—e.g., adding instant coffee powder would be one step). This is done by classifying the steps into actions. The actions are divided into sequential steps, e.g., step 1: pick up the screwdriver; step 2: unscrew the screw; step 3: remove the cover from the box. At step 406, actions which are classified to be meaningless are removed from the data. For example, if there was a “step 2b: check mobile phone” in the above example, it should be removed as the step of the expert checking their mobile phone is irrelevant to the completion of the task. The actions are then clustered together as a sequence of expert user actions 140. At step 408, the sequence of actions 140 is saved in the expert knowledge database 150. Each sequence of actions is associated with one task. This allows a specific task to be searched for in the database 150 to bring up the sequence of actions required for that task.

To summarise how the data is analysed, the system classifies the expert data (the real-time expert data 102a) into expert actions. A group of actions can be clustered into a sequence of expert actions (which can be referred to as a task). Classification can be done by training CNNs using expert knowledge capture via diverse inputs from the plurality of sensors (e.g., hand tracking, eye gaze, wearable camera), correlating them to pre-defined actions. For example, expert data from hand tracking identifies a circular hand movement, and expert data from the wearable camera identifies a screwdriver via object detection. The system then correlates (classifies) the expert data to the expert action “screwing” using pre-defined rules. If action 1 was “screwing” and action 2 was identified as “removing part” then the task is labelled as “installation”. The expert actions “screwing” and “removing part” are clustered into a sequence of expert actions which make up “installation”.

### Real-time Task Check and Novice User Assistance

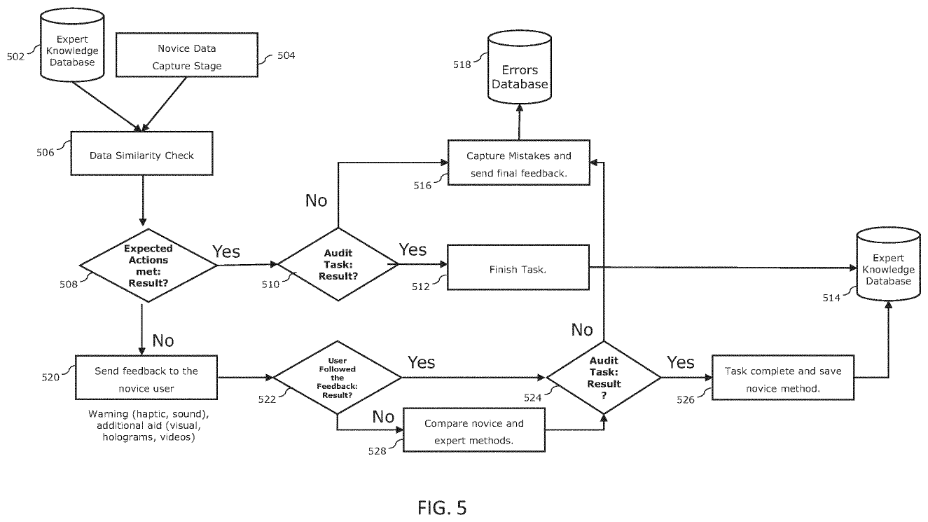

Once the expert's activities have been classified into actions and then clustered into tasks, the resulting information will be used to assist novice users who may require the same knowledge (i.e., assistance completing the same task(s)). The following description is illustrated by FIG. 5.

At step 504, data relating to the novice user's actions and task(s) (“novice data” 103) is collected in the same manner as described above in relation to the collection of expert data 102, see section titled “Data Collection”.

The analysis of the novice data 103 may be performed in real-time by novice data analysis program 132, so that real-time assistance can be provided to the novice user. The novice data analysis is performed in a similar manner to the expert data analysis described above, see section titled “Expert Data Analysis”. The difference between the expert data analysis and the novice data analysis is that the novice data analysis is performed in real-time (i.e., during the task, online) so that real-time feedback can be provided whereas the expert data analysis can be performed offline, after the task has been completed. The novice data analysis program outputs novice action data 142.

At step 506, the novice assistance program 132 checks the expert knowledge database 150, 502 for similar tasks to the one the novice user is attempting. The novice assistance program may base this check on the initial novice data 103 collected at the start of the novice's attempt of the task or the initial novice action data 142 outputted in real-time as the novice begins the task. The program may additionally or alternatively base this check on pre-existing data such as task description. This allows the novice assistance program 132 to find expert (tacit) knowledge related to the task the novice user is attempting. This check is performed using a conventional AI technique known as similarity learning (see definition section above). Similarity learning may involve techniques such as regression, classification and/or ranking. The similarity check may compare elements such as static task information (pre-existing data 103b), spatial information, and initial novice user activity (real-time data 103a) to existing entries. In other words, the similarity check 506 (as part of the novice assistance program 134) compares corresponding elements of the expert data 102 and/or the expert action data 140 to the initial novice data 103 and/or the initial novice action data 142. For example, the check may compare task descriptions, task locations, object detection, or any other data between the novice 103 and expert 102 data. Once a similar entry is found in the expert knowledge database 150, the novice assistance program 134 starts tracking the novice user to identify similarities and/or differences using similarity learning techniques.

At step 508, the program 132 checks whether the novice user's actions are similar to the saved expert user's actions.

If the novice user's actions are similar to those saved in the expert knowledge database 150 (i.e., the novice is performing similar actions to those recorded of the expert), then the program 132 checks whether the actions produced the desired result of the task (step 510).

If the desired results were achieved, the task is finished (step 512) and the successful result is saved in the expert knowledge database 150 (step 514).

If the desired results were not achieved, mistakes 146 are captured (step 516) and saved to the errors database 152, 518. Final feedback may also be sent to the novice to notify the novice user of what they did wrong.

If the novice user's actions are not similar to those saved in the expert knowledge database 150 (i.e., the novice is performing different actions to those recorded of the expert), then the novice user is provided with feedback (step 520) in the form of one or more of: haptics, sound, visual aids such as images, holograms, and any types of 2D/3D multimedia to attempt to guide them to perform actions more similar to those of the expert.

At step 522, the novice assistance program 134 checks if the novice user is following the feedback. This is done by continuous real-time data 103a collection and real-time novice data analysis by the novice data analysis program 132, as described above. The novice assistance program 134 continues to monitor the similarity between the novice action data 142 outputted by the novice data analysis program 132 and the expert action data 140 using the similarity learning techniques described above.

The outcome of the novice's actions is analysed to understand whether the novice user completed the task using a new methodology or they followed the system's feedback to complete the task.

If the novice follows the feedback the program 134 analyses whether the task was successfully completed (step 524). If the task was not successfully completed, mistakes 146 are captured (step 516) and saved to the errors database 152, 518. Final feedback may also be sent to the novice to notify the novice user of what they did wrong. If the task was successfully completed, the task is finished (step 526) and the successful result is saved in the expert knowledge database 150 (steps 526, 514).

If the novice does not follow the feedback, the program 134 compares the novice's method to the saved expert's method (step 528). The program 134 analyses whether the task was successfully completed (step 524). If the novice does not follow the feedback but successfully completes the task, the novice assistance program 134 may output novice action data as a new methodology (new method data 144) and save the novice's new methodology to the expert knowledge database 150 (step 526).

If the novice does not follow the feedback and fails to complete the task, the novice assistance program 134 may output novice action data as mistakes (mistake data 146) and save these mistakes to an errors database 152.

To summarise how assisting the novice user may work, novice data is collected, comprising raw novice user actions such as their hand and body position/rotation, and their interactions with the environment. This can be structured as an array of entries that later are compared to another array of entries from the expert system (expert actions). Data may be stored in the database 150 as arrays. So, a single array may be a step of an action (e.g., boiling water), a collection of arrays (2-dimensional) would be an action (e.g., adding hot water to the cup). The system may initially compare the steps (i.e., steps of an action) to other existing steps in the database 150 using the similarity check described herein, then find possible tasks the novice user might be doing based on that similarity check and start a more thorough search inside each stored expert task to understand which point the user is at. I.e., the user may be half way through the task-in which case, the system should start guiding them from that point, not from the beginning of the task.

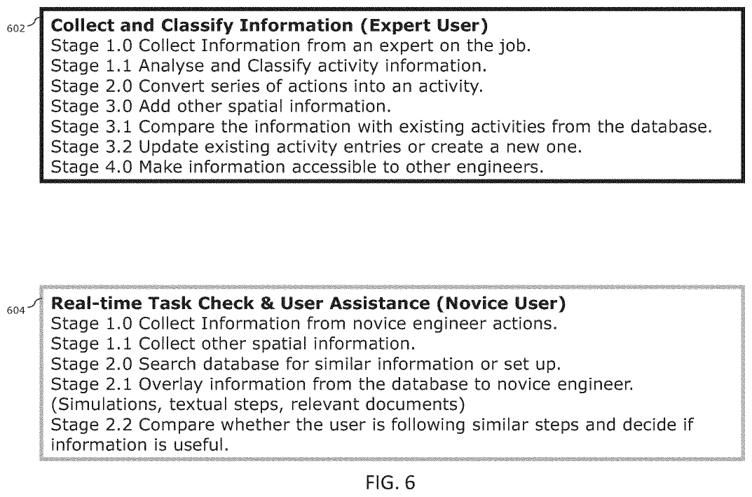

FIG. 6 illustrates an embodiment of the present invention. Box 602 outlines the collection and analysis of the data from the expert user. Stage 1.0 is to collect the data 102 (real-time data 102a) from an expert user while they complete a task. Stage 1.1 is to analyse and classify the data 102 relating to the activities of the expert user (e.g., the expert user's activity information and/or the context information as described in the “Data Collection” section), as described above in the “Expert Data Analysis” section. Stage 2.0 is to convert the sequence of actions into a task (or “activity”). A sequence of actions is converted into a task or activity once we identify that the expert user has completed the task. This can be identified by a significant change in what they are doing, e.g., logging off from the system. The system identifies and classifies the data into clusters as previously described. Stage 3.0 is to optionally add other spatial information such as the environmental information discussed in the “Data Collection” section which may increase the accuracy of the analysis. Stage 3.1 is to compare the information with existing tasks from the expert knowledge database 150. Stage 3.2 is to update existing activity entries (if a similar task is found) or create a new entry in the database 150. Stage 4.0 is to make the updated expert knowledge database 150 accessible to other engineers.

Box 604 outlines the real-time check and novice user assistance. Stage 1.0 is to collect data 103 from novice engineer actions. Stage 1.1 is to optionally collect other spatial information. Stage 2.0 is to search the expert knowledge database 150 for similar information or set up. Stage 2.1 is to relay information from the expert knowledge database 150 to the novice engineer via feedback. This may be done using simulations, textual steps and/or relevant documents. Stage 2.2 is to compare whether the novice user is following similar steps to the saved expert user's steps and decide if the information provided by the novice user's technique is useful (whether that be for saving as a mistake 146 and refining feedback or saving as a new and improved method).

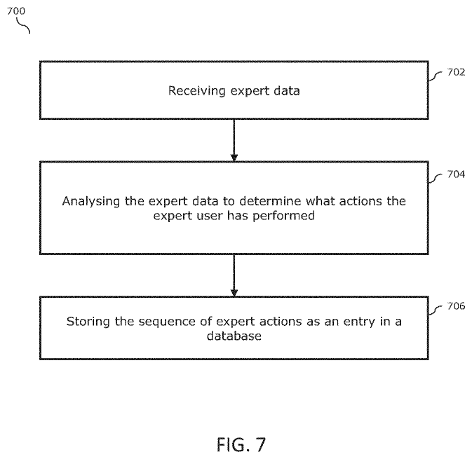

FIG. 7 illustrates an embodiment of the present invention, method 700 for capturing tacit knowledge data from an expert user. At step 702, expert data 102 is received. The expert data 102 comprises expert real-time data 102a received while the expert user performs a task, the expert real-time data 102a comprising expert sensor data from a first plurality of sensors monitoring the expert user and/or the expert user's surroundings. The expert data 102 may further comprise pre-existing data 102b relating to a task description or technical documentation related to the task. The expert sensor data may comprise data relating to one or more of: the expert user's body position, the expert user's hand position, the expert user's hand rotation, the expert user's hand gestures, the expert user's body gait, the expert user's eye gaze, location of the expert user within the expert user's surroundings, sound in the expert user's surroundings, light intensity in the expert user's surroundings, temperature in the expert user's surroundings, objects detected in the expert user's surroundings, and/or objects detected which the expert user is interacting with. The first plurality of sensors may comprise one or more of: wearable sensors worn by the expert user, a camera, an eye tracker, a heart rate sensor, wrist bands, a microphone, a light sensor and/or a thermometer.

The expert sensor data may be advantageously synchronised such that data from all the different sources/sensors are in sync. For example, it may be necessary to synchronise data from a camera, data from wrist bands and data from eye trackers such that the data from each sensor is aligned in time. E.g., at T=0, there is eye tracker data, wrist band data and camera data. This may be necessary due to different lags from the different sensors. E.g., it may take longer for the camera data to be sent to the system than the wrist band data. Synchronisation is then needed so that it can be seen that at T=X, camera data was Y and wrist band data was Z.

At step 704, the expert data 102 is analysed using artificial intelligence to determine what actions the expert user has performed. This may be done by classifying the expert data 102 to determine expert actions that the expert has performed, optionally removing meaningless actions from the determined expert actions, and clustering the expert actions into a sequence of expert actions 140.

At step 706, the sequence of expert actions 140 is stored as an entry in a database (expert knowledge database 150). The database 150 comprises one or more entries.

The stored sequence of expert actions 140 may then be used to guide a novice user attempting to complete the task.

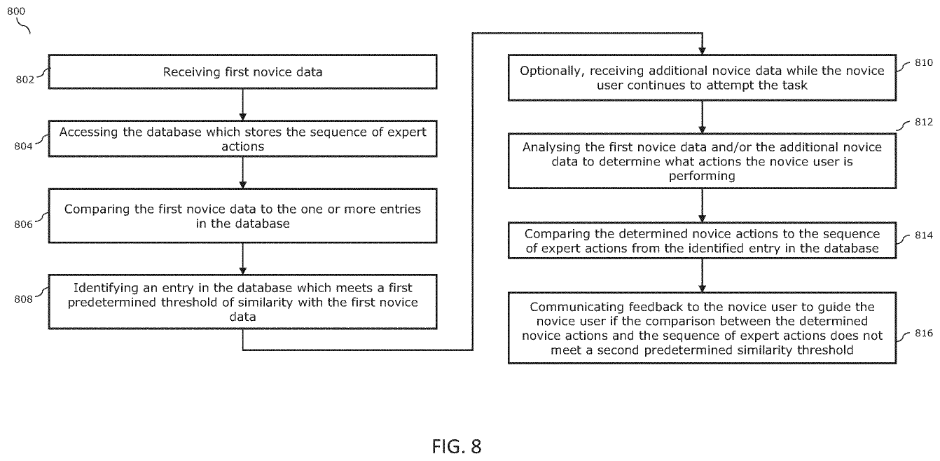

FIG. 8 illustrates an embodiment of the present invention, method 800 for guiding a novice user attempting a task. At step 802, first novice data 103 is received. The first novice data 103 comprises first novice real-time data 103a received while the novice user attempts the task, the first novice real-time data 103a comprising first novice sensor data from a second plurality of sensors (which may differ to the first plurality of sensors used to capture tacit knowledge from the expert user) monitoring the novice user and/or the novice user's surroundings. The first novice data 103 may further comprise pre-existing data 103b relating to a task description or technical documentation related to the task.

The first novice sensor data may comprise data relating to one or more of: the novice user's body position, the novice user's hand position, the novice user's hand rotation, the novice user's hand gestures, the novice user's body gait, the novice user's eye gaze, location of the novice user within the novice user's surroundings, sound in the novice user's surroundings, light intensity in the novice user's surroundings, temperature in the novice user's surroundings, objects detected in the novice user's surroundings, and/or objects detected which the novice user is interacting with. The second plurality of sensors may comprise one or more of: wearable sensors worn by the novice user, a camera, an eye tracker, a heart rate sensor, wrist bands, a microphone, a light sensor and/or a thermometer.

As with the expert sensor data, the novice sensor data may be advantageously synchronised such that data from all the different sources/sensors are in sync.

At step 804, the database 150 which stores the sequence of expert actions 140 (as described above in relation to method 700) is accessed.

At step 806, the first novice data 103 is compared to the one or more entries in the database 150, each of the one or more entries containing a sequence of expert actions 140.

At step 808, an entry in the database 150 which meets a first predetermined threshold of similarity with the first novice data 103 is identified. The first predetermined threshold of similarity may be calculated using a similarity function which optionally comprises one or more of: regression, classification, ranking and local sensitive hashing (LSH).

Optionally, at step 810, additional novice data 103 is received while the novice user continues to attempt the task. The additional novice data 103 comprises additional novice real-time data 103a, the additional novice real-time data 103a comprising additional novice sensor data from the second plurality of sensors. The additional novice data 103 is similar to the first novice data 103, but captured at a later time.

At step 812, the first novice data 103 and/or the additional novice data 103 is analysed to determine what actions the novice user is performing by classifying the novice data 103 and/or the additional novice data 103 to determine novice actions 142 that the novice user is performing. In some embodiments, the later data (the additional novice data 103) may be analysed by itself to determine the actions 142. In other embodiments, the later data (the additional novice data 103) may be analysed along with the earlier data (the first novice data 103) to give a greater data set from which to determine the actions 142 from.

At step 814, the determined novice actions 142 are compared to the sequence of expert actions 140 from the identified entry (the entry which comprised expert data 102 similar to the novice data 103) in the database 150.

At step 816, feedback is communicated to the novice user to guide the novice user if the comparison between the determined novice actions 142 and the sequence of expert actions 140 does not meet a second predetermined similarity threshold (i.e., the novice 142 and expert actions 140 are not considered similar, they are different (as determined by the predetermined threshold)). The second predetermined threshold of similarity may be calculated using a similarity function which optionally comprises one or more of: regression, classification, ranking and local sensitive hashing (LSH).

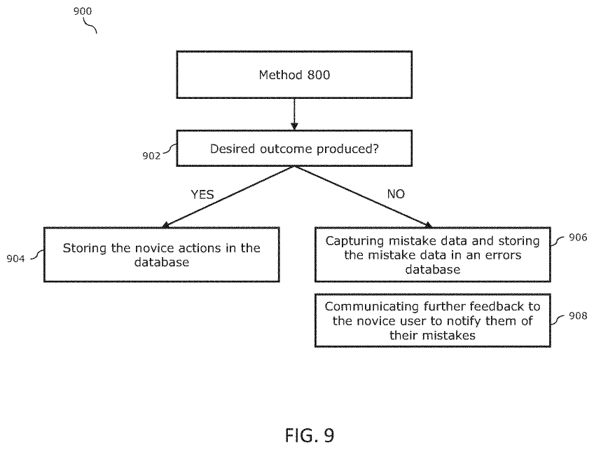

FIG. 9 illustrates an embodiment of the present invention which continues on from method 800 described immediately above. At step 902, the system checks whether or not the novice actions 142 produced a desired outcome of the task (e.g., successfully fixing a piece of equipment). If the desired outcome was produced, at step 904 the novice actions 142 may be stored in the database 150 as new method data 144. If the desired outcome was not produced, at step 906 mistake data 146 may be captured and stored in an errors database 152. Optionally, at step 908 further feedback may be communicated to the novice user to notify them of their mistakes.

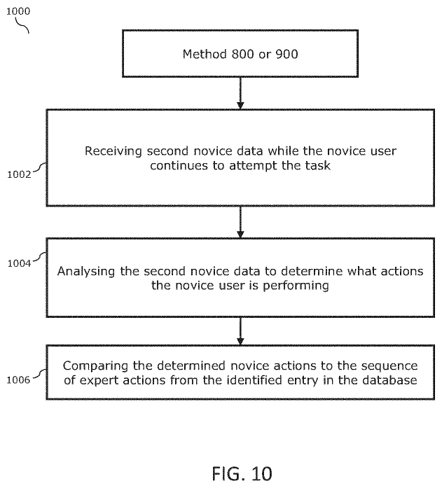

FIG. 10 illustrates an embodiment of the present invention for checking if the novice user is following the feedback which continues on from method 800 or 900 described immediately above. At step 1002, second novice data 103 is received while the novice user continues to attempt the task. The second novice data 103 comprises second novice real-time data 103a, the second novice real-time data 103a comprising second novice sensor data from the second plurality of sensors. The second novice data 103 is similar to the first and additional novice data 103 but captured at a later time once feedback has been communicated to the novice user.

At step 1004, the second novice data 103 is analysed to determine what actions the novice user is performing by classifying the second novice data 103 to determine novice actions 142 that the novice user has performed (i.e., checking what actions the novice user is performing in response to the feedback).

At step 1006, the determined novice actions 142 are compared to the sequence of expert actions 140 from the identified entry in the database 150. This checks whether the novice user is now performing similar actions to the expert user, as a result of the feedback. This is assessed using the second predetermined similarity threshold. If the comparison between the determined novice actions 142 and the sequence of expert actions 140 still does not meet a second predetermined similarity threshold, further feedback may be communicated to guide the novice user. Dependent on whether or not the novice user successfully completes the task, an alternative method used by the novice (i.e., a series of actions which does not meet the second predetermined similarity threshold) may be captured as mistake data 146 and saved to the errors database 152 (if task not successfully completed) or captured as alternative expert data (new method data 144) and saved to the expert knowledge database 150 (if task successfully completed). In this way, the method 900 of FIG. 9 may be performed after the method 1000 of FIG. 10.

### Examples of Invention in Use

One example scenario related to embodiments of the present invention is teaching engineers how to install internet to premises. Successful installations can be captured from expert field engineers (expert users), following the tacit knowledge capture process described herein. Other field engineers (novice users) can then benefit from this knowledge through an application that will display the sequence of actions that they need to do and let them know if they are doing the actions the same way as the expert field engineers. The application will capture the actions from the field engineer and compare them to the knowledge database and let them know if they are doing the actions as expected. By capturing knowledge from an expert engineer and using that knowledge for real-time task checks to provide user assistance, then it is possible to advice the field engineer via feedback on how to fix the errors and avoid the cost of a revisit to the installation site. Additionally, this will reduce the number of resources needed for auditing current and future installations.

In another example, embodiments of the present invention may be used to provide a service for people to share and sell their expert knowledge to consumers (e.g., a carpenter (expert user) wearing an immersive wearable that captures and analyses their activity to construct steps around how to build furniture from scratch like an expert).

Various modifications whether by way of addition, deletion, or substitution of features may be made to above described embodiment to provide further embodiments, any and all of which are intended to be encompassed by the appended claims.

1. A computer-implemented method for capturing tacit knowledge data from an expert user, the method comprising:
receiving expert data, the expert data comprising expert real-time data received while the expert user performs a task, the expert real-time data comprising expert sensor data from a first plurality of sensors monitoring the expert user and/or the surroundings of the expert user;
analysing the expert data using a machine learning system to determine what actions the expert user has performed, wherein the analysing comprises:
classifying the expert data to determine expert actions that the expert has performed; and
clustering the expert actions into a sequence of expert actions; and
storing the sequence of expert actions in a database.

2. The method of claim 1, further comprising using the stored sequence of expert actions to guide a novice user attempting to complete the task.

3. The method of claim 1, wherein the method further comprises synchronising the expert sensor data from the first plurality of sensors prior to the analysis.

4. The method of claim 1, wherein the expert data further comprises pre-existing data relating to a task description or technical documentation related to the task.

5. The method of claim 1, wherein the analysing further comprises removing meaningless actions from the determined expert actions prior to the storing step.

6. The method of claim 1, wherein the expert sensor data comprises data relating to one or more of: the expert user's body position, the expert user's hand position, the expert user's hand rotation, the expert user's hand gestures, the expert user's body gait, the expert user's eye gaze, location of the expert user within the expert user's surroundings, sound in the expert user's surroundings, light intensity in the expert user's surroundings, temperature in the expert user's surroundings, objects detected in the expert user's surroundings, and/or objects detected which the expert user is interacting with.

7. The method of any claim 1, wherein the first plurality of sensors comprises one or more of: wearable sensors worn by the expert user, a camera, an eye tracker, a heart rate sensor, wrist bands, a microphone, a light sensor and/or a thermometer.

8. A computer-implemented method for guiding a novice user attempting a task, the method comprising:
receiving first novice data, the first novice data comprising first novice real-time data received while the novice user attempts the task, the first novice real-time data comprising first novice sensor data from a second plurality of sensors monitoring the novice user and/or the surroundings of the novice user;
accessing a database which stores one or more sequences of expert actions, wherein the one or more sequences of expert actions have been determined by processing data captured from an expert user;
comparing the first novice data to the one or more sequences of expert actions;
identifying a sequence of expert actions which meets a first predetermined threshold of similarity with the first novice data;
analysing the first novice data using a machine learning system to determine what actions the novice user is performing, wherein the analysing comprises:
classifying the first novice data to determine novice actions that the novice user is performing;
comparing the determined novice actions to the sequence of expert actions from the identified sequence of expert actions in the database;
communicating feedback to the novice user to guide the novice user if the comparison between the determined novice actions and the sequence of expert actions does not meet a second predetermined similarity threshold.

9. The method of claim 8, wherein the one or more sequence of expert actions stored in the database have been determined by processing data captured from the expert user.

10. The method of claim 8, the method further comprising checking whether or not the novice actions produced a desired outcome of the task; and optionally:
storing the novice actions in the database if the desired outcome of the task was produced; and/or
capturing mistake data and storing the mistake data in an errors database if the desired outcome of the task was not produced; and/or
communicating further feedback to the novice user to notify them of their mistakes if the desired outcome of the task was not produced.

11. The method of claim 8, the method further comprising checking if the novice user is following the feedback by:
receiving second novice data while the novice user continues to attempt the task, the second novice data comprising second novice real-time data, the second novice real-time data comprising second novice sensor data from the second plurality of sensors;
analysing the second novice data using artificial intelligence to determine what actions the novice user is performing, wherein the analysing comprises:
classifying the second novice data to determine novice actions that the novice user has performed;
comparing the determined novice actions to the sequence of expert actions from the identified sequence of expert actions in the database.

12. The method of claim 8, wherein the first and/or second novice data further comprises pre-existing data relating to a task description or technical documentation related to the task.

13. The method of claim 8, wherein the first and/or second predetermined threshold of similarity is calculated using a similarity function which optionally comprises one or more of: regression, classification, ranking and local sensitive hashing (LSH).

14. The method of claim 8, wherein the feedback is communicated via one or more of: visual communication methods, auditive communication methods or haptic feedback; and optionally:
wherein visual communication methods comprise one or more of: holograms, diagrams, or animations of the expert actions; and/or
wherein auditive communication methods comprise voice guided instructions; and/or
wherein haptic feedback is via one or more of: haptic response to controllers or haptic gloves.

15. A system comprising: a processor; and a memory including computer program code;
the memory and the computer code configured to, with the processor, cause the system to perform the method of claim 1.
